(19) United States
(12) Patent Application Publication
(10) Pub. No.: US 2008/0255917 A1
(43) Pub. Date: Oct. 16, 2008

(54) Method For Business Management

(75) Inventors: Dowlin D. Mayfield, Freeport, FL (US); Brian Allen Lewis, Bimingham, AL (US); Stephen Randdph Speck, Quincy, FL (US)

Correspondence Address: GREENBERG & LIEBERMAN, LLC, 2141 WISCONSIN AVE, N.W., SUITE C-2, WASHINGTON, DC, 20007, US

(73) Assignee: D Mayfield Enterprises, Inc., Destin, FL (US)

(21) Appl. No.: 11/734,635

(22) Filed: Apr. 12, 2007

(51) Int. Cl. G06F 9/46

(52) U.S. Cl. 705/9

(57) ABSTRACT

A method for managing the complete workflow of a personnel network-oriented business that allows those at varying levels of the company hierarchy to manage, monitor, assign, accept and fulfill their client obligations through an interactive software-based process. Secure levels of administration and delegation combine with an array of links that ultimately organize workflow from beginning of a client file to the end.

### FIELD OF THE INVENTION

The present invention relates to an interactive software-based method for managing, monitoring and assigning client files for the duration of its existence in regard to a personnel network-oriented business through the use of assignment maps, manage client links, manage user links, manage events links, status maps, various monitoring links and many other elements to maintain an efficient and cost-effective workflow.

### BACKGROUND OF THE INVENTION

In 2004, there were about 3.4 million catastrophic insurance claims in the U.S. costing the insurance business billions of dollars. This statistic from the Insurance Services Office doesn't even touch other claims where an adjuster is dispatched. But what this means is that the claims business can be very hectic as adjusters are dispatched to the location of an insurance claim. Making this even more vital is the fact that insurance claims often relate to a family's home and/or livelihood. Claims adjusters have the important task of expeditiously entering the location of the claim in order to satisfy the insurance issue. Without the work of the claims adjuster, then significant time, money and hardship would fester upon a family who already is likely facing severe hardship. In that regard, it is vitally important for a claims business to efficiently, effectively, and instantly monitor and delegate all facets of the adjusters' ability to get to and ultimately work from a stricken location.

Similar issues confront those in other business as well. Construction contractors, appraisers, real estate agents, salespeople, and many other service-oriented industries remain under hectic conditions with expansive assignment elements. Administrators in these industries must find, qualify and seek out the right personnel. And when these personnel are located, many nuances and details must be hashed through. Those details may not even include such important aspects as scheduling, assignment and specific tasks. Monitoring also becomes an issue as multiple people are doing multiple things in whatever industry is involved.

The insurance claims industry is merely one business that needs an all-encompassing method for searching, finding, assigning and managing the multitude of issues and personnel involved in workflow. This need is important to many of these businesses because customers often are relying on whatever service is being provided. In the insurance industry, for example, after a claim is filed, it is often best to have a claims adjuster dispatched within 24 hours. Especially for catastrophic claims, these issues are time sensitive and need to be handled quickly. At the same time, claims managers must dispatch the adjusters beyond the usual areas of organization. Such issues as hotels, location, weather, licenses and current workload all must be taken into account when a manager is deciding whom to dispatch to a claim site. Although these issues may appear small or inconsequential by themselves, they in fact add up to be absolutely vital to the flow of the claims adjusting process. To this end, there is a substantial need for integrated and all-encompassing software that is user-friendly and takes virtually every conceivable aspect of the claims adjustment process into account to ultimately establish an efficient business flow. In addition, this need transcends the insurance claims industry and needs to be adaptable to other businesses as well. Like the insurance claims industry, businesses with strong support-personnel networks need a method for searching, finding, assigning and managing the multitude of issues and personnel involved in workflow.

Within the claims adjustor industry, a number of crucial and time-sensitive events must occur after the initial claim is filed. Moreover, once these events culminate with the arrival of the adjustor to the location of the claim, it is equally crucial to have the effectiveness of that adjustor sustained while at the scene. In short, it is equally important to get the correct adjustor to the scene while at the same time maintaining the adjustor's effectiveness. For example, when a claim is reported to a central office, an administrator must perform a number of tasks before an adjustor is actually dispatched. The administrator may have 100 or more claims to handle at one time. This would require quick delegation to team leaders on down the hierarchal line of the network. In addition, many of these claims will likely be in different locations across the country. This means that the administrator or his delegated authority must wade through vast amounts of information to locate an adjustor in relative close proximity to the claim location. But the process does not stop there. The authority must learn whether the potential adjustors in that location can even handle a claim. The authority also must learn whether the potential adjustor is licensed and thus even qualified to handle the claim. In fact, numerous elements of criteria must be sifted through in order to dispatch one claims adjustor. Even if an adjustor is qualified and in location, other extraneous factors such as lodging, weather, road conditions, etc must be taken into account to ensure that this particular adjustor will be able to fully perform his or her duty in a timely fashion.

Of course the tasks and managing duties of the administrator or his or her delegated authorities does not stop with the arrival of the adjustor. These individuals are responsible for potentially hundreds upon hundreds of claims. At all times, these authorities must monitor the progress and status of each claim, as well as the adjustors who may or may not be assigned to handle the claim. This organization is vastly important because the claims industry literally is responsible for the well-being and livelihood of families. This means that there is a need for a claims authority to be able to instantly check the status of each claim from its unassigned status to closure and all elements in between. In addition, the authority also must be able to deal with any issues or new claims that arise either in the same location or elsewhere. There are many more differing elements that authorities need to monitor in order to maintain a smooth flow of the claims process. In that regard, there is a substantial need for a computer program that can perform all of these monitoring functions combined with the delegation and practical elements associated with the flow of multiple claims from before adjustor assignment to closure. This need should also not be limited to just the claims industry, but should be adaptable to other industries as well with equally demanding networks of support personnel.

Administrators in such industries as insurance claims have attempted to use various programs out there to try and organize various aspects of their business. For example, adjustors often must use a program known as XACTIMATE™ or its offshoot XACTANALYSIS™ when they work on claims. This program is functioned to handle price and fee issues associated with the claims and other businesses. However, XACTIMATE™ and its similar offshoots differ from the present invention because those attempts do not engage in the all-encompassing flow of multiple claims from its initial filing to closure. Because of this, there remains a need for industries such as insurance claims for an all-encompassing, integrated and user-friendly program that takes virtually all elements of the process from beginning to end and crafts it into an efficiently flowing system.

U.S. Pat. No. 6,810,383 issued to Loveland on Oct. 26, 2004, is an automated task management and evaluation system used as an online tool in conjunction with XACTIMATE™. That item uses a computer-oriented system to assign tasks to service providers where they can be evaluated. Unlike the present invention, that item does not delve into various in-depth areas of the assignment process such as the building of teams, status indicators or assignments through the use of criteria breakdowns. In addition, unlike the present invention, that item does not allow for an administrator to see the severity of the job before it is assigned, nor does that item have a mapping function used to track many relevant items down to minute but important details such as weather, location and nearby personnel possessing specific criteria requirements.

U.S. Pat. No. 5,950,169 issued to Borghesi et al on Sep. 7, 1999, is a method for managing insurance claim processing. That method attempts to utilize computer technology to maintain financial information, claim assignment and claim information. Unlike the present invention, Borghesi merely serves as a database and informational tool and does not allow for highly integrated monitoring and detailed attention to virtually all facets of the claims process flowing from initial filing to closure.

There remains a substantial need for a method that allows an administrator or delegated authority to instantly monitor and expeditiously control a service-oriented business such as insurance claims in virtually every aspect from a time before the claim is assigned to its closure. The present invention satisfies that need by providing administrator and owners an efficient piece of mind that the job is getting done down to the most minute of details.

### SUMMARY OF THE PRESENT INVENTION

The present invention is a method that permits an administrator and others at various levels of the chain of command of a business to manage virtually every aspect of that business from beginning to end. The present invention is especially relevant to the insurance claims industry although it is certainly adaptable to fit other types of businesses as well. Many of the examples in the summary relate to the insurance claim industry, but it should be stressed that the insurance claim industry is merely one embodiment of the present invention. Real estate, contractors, appraisers and salespeople are just a few of the many service-oriented businesses that apply to the present invention. The present invention is a method that utilizes software featuring various screens, options and instant information that can be accessed through an online network. The levels of access vary from the administrator level down to such items as team leaders and individual employees or contractors. This means that the top administrator has complete access to the entire program. At this level, an administrator can delegate claims or personnel to a team leader who then can have access in order to further delegate claims to those claims adjustors under his or her responsibility. The present invention is essentially an all-encompassing method for searching, finding, assigning and managing the multitude of issues and personnel involved in workflow.

The present invention allows for virtually all aspects related to managing a business like the insurance claims industry. The ultimate function of the present invention is to provide the administrators with the ability to effectively manage the flow of the business from beginning to closure. In the realm of the insurance claim industry, an administrator can use the present invention to manage its adjustors. An embodiment of the method relating to the insurance claim industry may use numerical values as an indication of status. The numbers in this embodiment can relate to the status of an insurance claim. For example, 0 signifies that no adjuster has been assigned to a specific claim. 1 means that an assignment was made but has not yet moved to take on the claim. 2 tells the administrator that the adjuster had indeed picked up the claim while 3 signifies that the adjuster has actually seen the insured individual involved and has uploaded various specific documents for review by administrator he has created for completion of the job. 4 provides information surrounding the appraisal and its approval while 5 states whether the claim was accepted or rejected. 6 indicates that the claim file is closed. Of course, the numerical status indicators are merely an embodiment of the present invention as other classifications are well within the capabilities of the present invention.

While these status numbers can indicate the status of each insurance claim, the present invention permits administrators and authorities to ensure complete and seamless flow throughout the entire process. In addition, the present invention is designed to cater to those dealing with multiple claims or business issues with an unlimited capacity. This is important because due to the time sensitive nature of insurance claims, the present invention makes it relatively easy and quick to manage contracted adjusters that each face 40-50 claims. The present invention allows managers and administrators to handle everything from assignments to determining geographical location and potential extraneous issues all while the flow from numbers 0-6 is occurring.

As soon as the administrator receives a claim, it should be regarded as time sensitive. The administrator can then use the present invention to map out the exact latitude/longitude/geographical location of the claim. The present invention can then offer a list of all claims adjusters within whatever distance from the claim location that the administrator chooses. Upon limiting the pool of potential adjusters to those within the specified proximity, the administrator can use the present invention to research various necessary criteria revolving around each adjuster. For example, the present invention details each potential adjuster's licensing credentials and past specific work experience. It also details whether the particular adjuster is accepting claims at that time and the number of claims he or she is already committed. The present invention also provides a numerical value as to the experience level of each claims adjuster. An embodiment of the present invention places these numerical values at 5 being very experienced and 1 as possessing the lowest amount of experience. The present invention permits the administrator to either manually enter criteria requirements or simply have the program save certain requirements automatically. After the pool of potential adjusters is limited to the specified criteria, the administrator or team leader can then assign these selected adjusters to various claims. In relation to the numerical values embodiment of the overall flow of the present invention, the assignment element would automatically change the claim information from 0 to 1 because the assignment was made. Letters or other form of classification also may represent these status indicators. Looking even further into the present invention, once the assigned adjuster accepts the claim into his or her responsibility, then the numerical information moves to 2.

The present invention also contains an assignment map that easily identifies each state where there are unassigned claims. Once a state is clicked, an administrator can click further into the map as he or she closes in on unassigned claims. This clicking process can go so far as to the street or even housing unit level of the map. This element of the present invention provides such information as the claim number and status of an insurance claim in regard to such items as habitability. Data on this area of the present invention also includes other organizational aspects such as the severity level of the claim and priority levels. This permits all parties from the administrator to the adjuster to make their schedule of which claims to visit first.

The present invention follows from the initial claim or contact for a service-oriented business and easily guides relevant personnel along through the workflow until the completion of that file. Included in this process is the monitoring of workflow and production levels of each and every party involved on individual, team wide, company wide and third party wide levels. In addition, the present invention allows for the assigning of personnel to handle the claim based on an intensive search criteria provided about the initial claim or job beforehand. Moreover, the present invention assists the individual assigned to a specific task by providing research data, investigation items, scheduling, forms and company-wide procedural information. The present invention also includes an easy method for communication between all parties involved in that specific job. Once that active job file is closed, the present invention allows for the complete monitoring of numerous other aspects of that job such as financial elements and liability issues.

### BRIEF DESCRIPTION OF THE PREFERRED EMBODIMENT

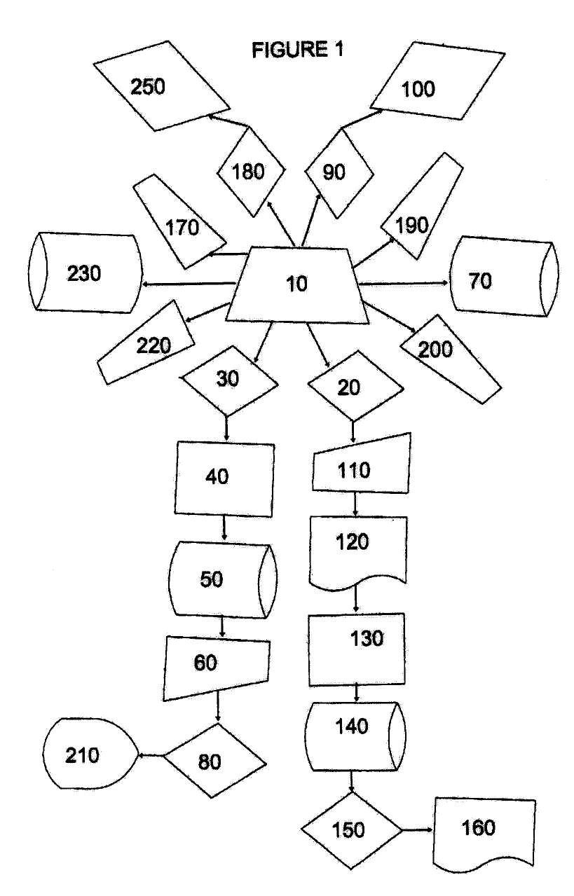

FIG. 1 is a flow chart of security level access of the present invention.

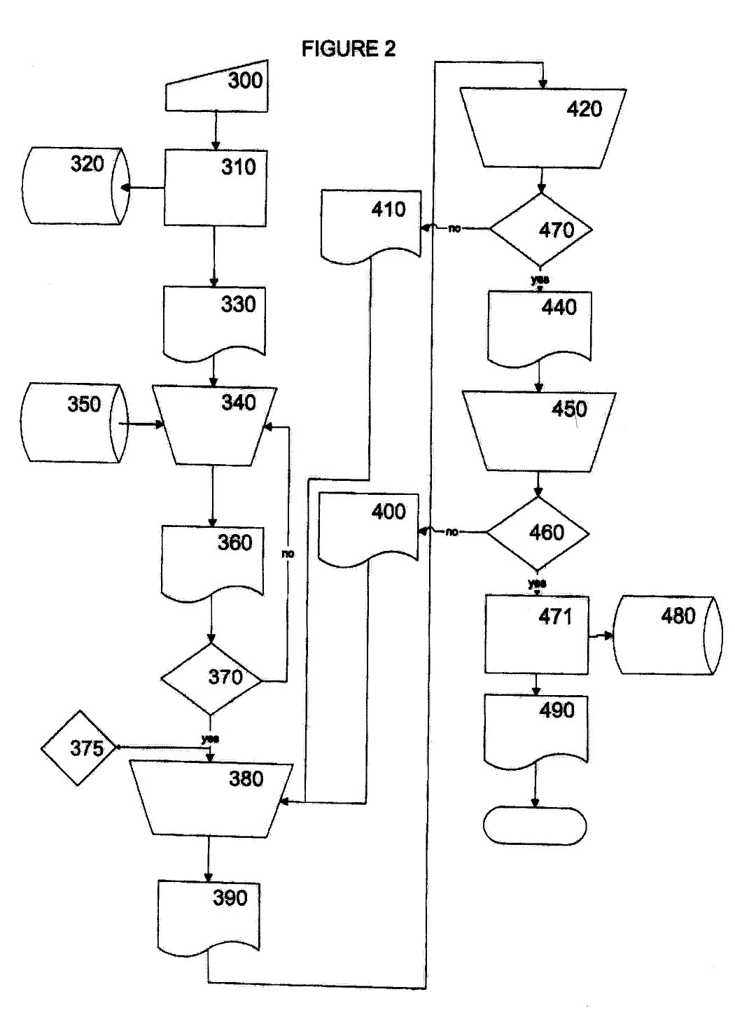

FIG. 2 is a flow chart of an embodiment of the present invention in regard to the workflow of a specific job.

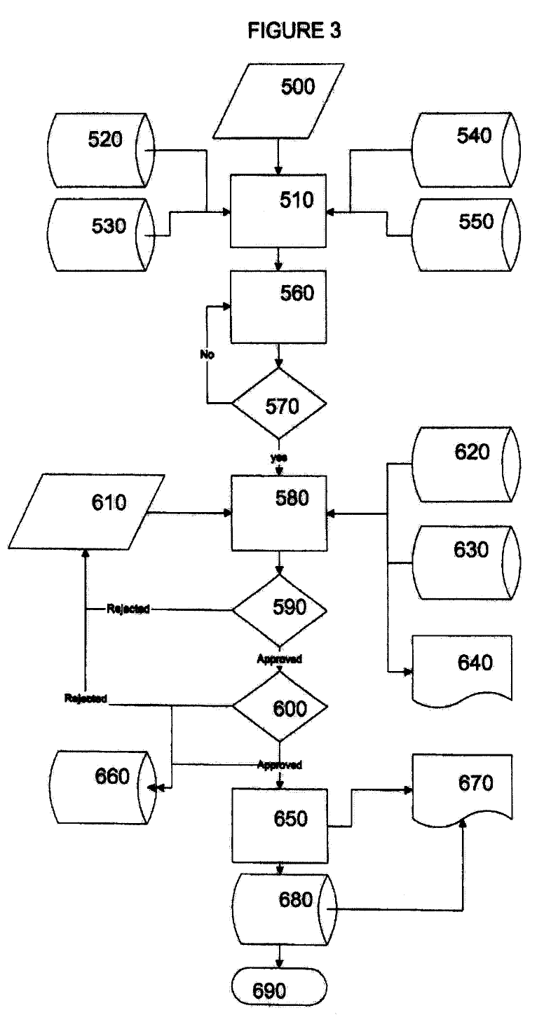

FIG. 3 is a flow chart of an embodiment of the present invention applied to the insurance claims industry.

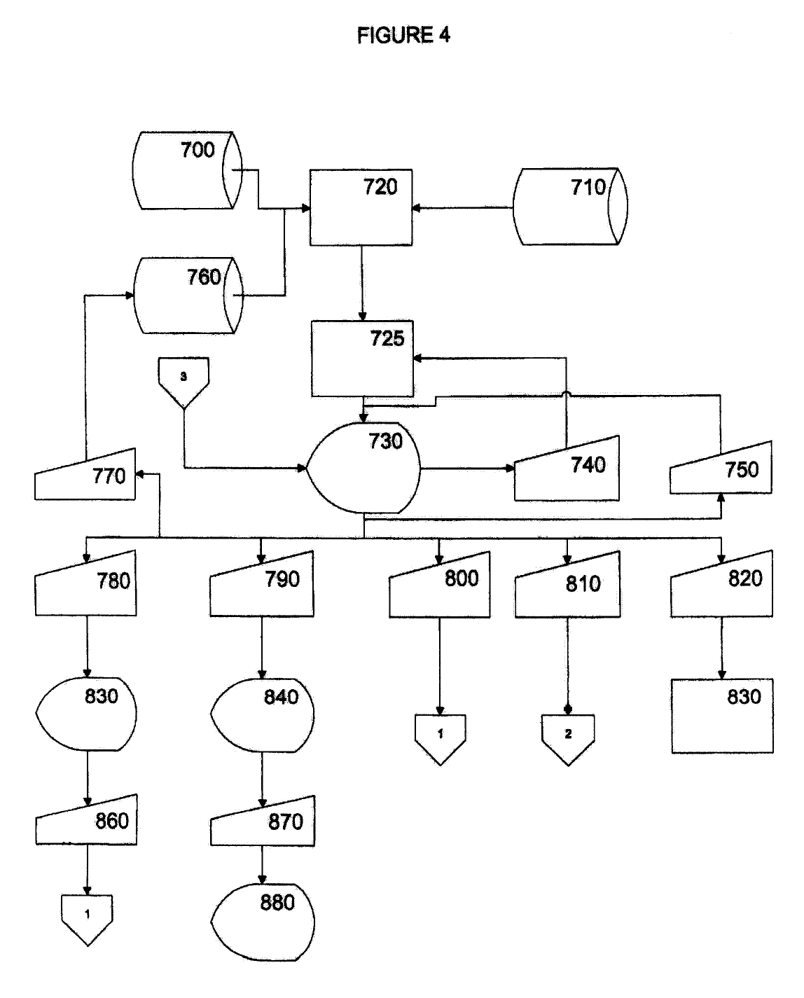

FIG. 4 is a flow chart of a service provider map and routing process of the present invention.

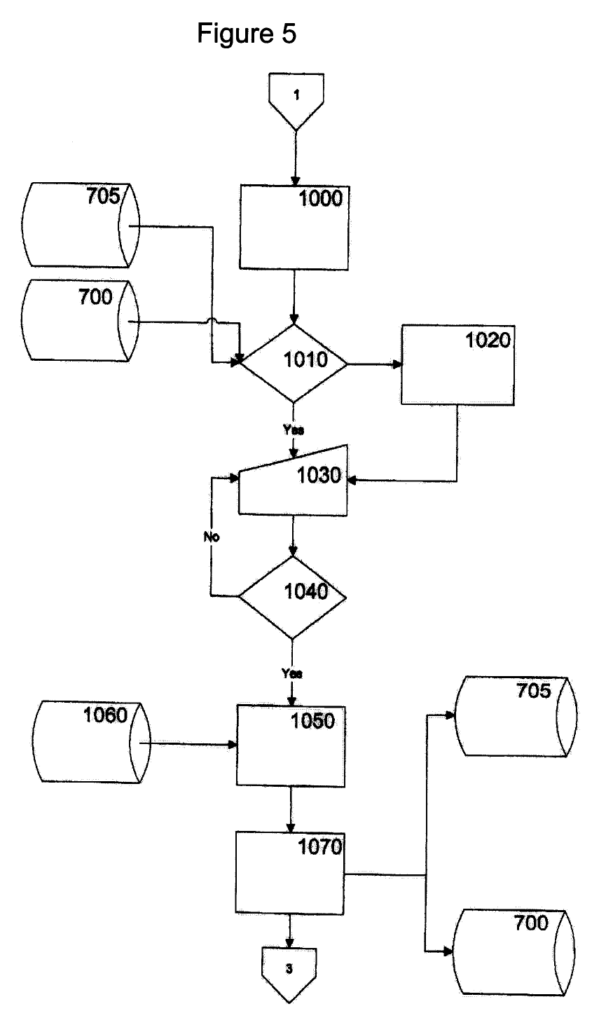

FIG. 5 is a continuation of the flow chart relating to the service provider map and routing process of the present invention.

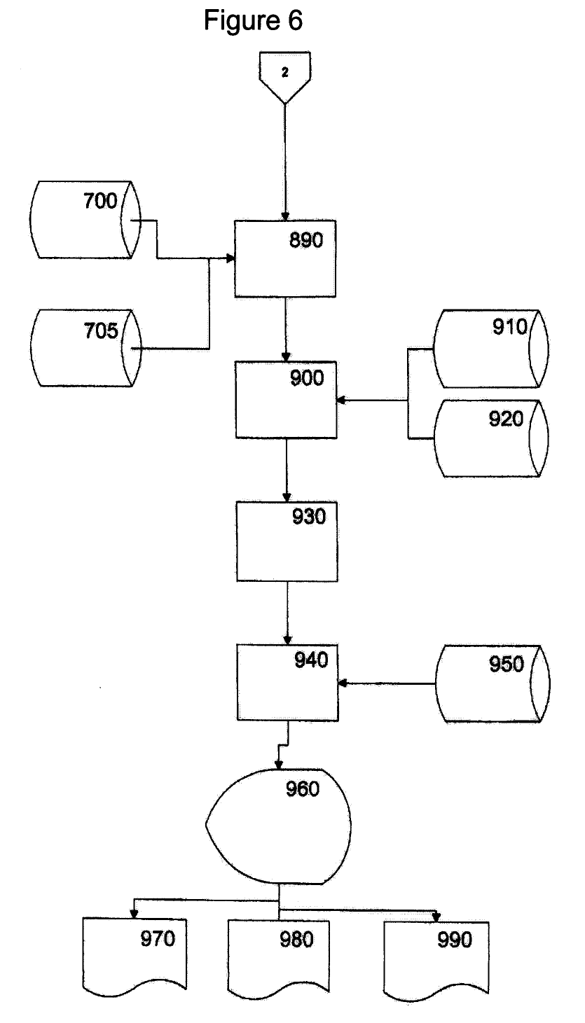

FIG. 6 is a further continuation of the flow chart relating to the service provider map and routing process of the present invention.

### DETAILED DESCRIPTION OF THE PREFERRED EMBODIMENT

In FIG. 1, we see a flow chart detailing the various security levels of the present invention. The security levels are important because each tier of security access permits a user to perform certain functions in regard to the present invention. The higher the tier, the more access a user has with the present invention. This allows for the differing elements in the chain of command structure to perform their tasks in a secure, efficient flow.

FIG. 1 shows us that regardless of the exact nature of the business, the preferred embodiment of the present invention has varying levels of security. Regardless of whether it is the insurance claims industry, real estate, construction contractor or other business, the top level of security for the present invention is that of the global administrator (10). The global administrator (10) is the highest level of security with complete access and privilege in relation to the present invention. The global administrator (10) has access to manage clients main tab (20), which means that the global administrator (10) can add and delete clients, as well as edit the client information and file information. This client information is on active links that can be clicked on by the user to be accessed. The manage clients main tab (20) also permits the global administrator (10) to click on a list users link (40) which shows all users currently in the system along with their contact information, locations, licenses, qualifications, experience and security level. In addition, the list users link (40) can be clicked so that the global administrator (10) view every client issue assigned to that user and the status of that client issue. To do this, the global administrator (10) merely needs to click on the user name to reveal all the pertinent information. Furthermore, the global administrator (10) can click add new users link (50) to enter and set all information about users who will be using the present invention. An additional element of this item is that the global administrator (10) can set the hierarchal chain of command for the security levels of the present invention.

An additional area where the global administrator has security privilege is to click on a manage personnel link (60). The manage personnel link (60), like many of the other links of the present invention, of course can have a costumed name to cater to the specific industry using the present invention. For example, the manage personnel link (60) can also serve to manage adjusters if the specific industry was the insurance claims business. In that instance, the global administrator (10) can view daily performance levels of not only such personnel as the lower-tiered account managers, but also those underneath that person. The manage personnel link (60) also permits the global administrator to build teams and chains of command for those teams based on such elements provided for in the present invention as location, experience or other specified criteria.

An additional element of the present invention where the global administrator has complete access is in the business specific software (70). Like many of the links associated with the present invention, the business specific software (70) can be named and catered to whatever the specific business is relating to the present invention. The example of the insurance claims industry could make this element into claims adjustor estimating software. When clicked, the business specific software (70) links the user into spreadsheets relating to such items as current pricelists being used. An additional aspect of the business specific software (70) element of the present invention is that a global administrator (10) or one of his or her delegates can enter this information into the system. If the information becomes out of date, the user who originally entered the information may receive an automatic email from the present invention informing the user of the situation. The present invention also allows the global administrator (10) or his delegates to send private emails through the group email function (80) to groups on the system. This means that an email can be sent to only account managers, team leaders or other groups of people at a certain position within the business. Beyond the group email function (80), the global administrator (10) also can access an email reminders link (210). This element of the present invention provides a global administrator (10) with complete access to edit and insert all of the relevant company contact information along with such other items as company logo, etc. into all auto-responding email accounts generated by the present invention. These email reminders (210) go out automatically to individuals at all levels of the company hierarchy. In addition, automatically generated email reminders (210) are dispatched upon certain predetermined benchmarks of the specific business item's span. These email reminders (210) inform various personnel of such items as deadlines and other business-specific information as time commences.

An additional element of the present invention permits the global administrator (10) to have access to a manage events/event stats link (90). This means that the global administrator (10) can access all events that are ongoing within his specific company. The global administrator (10) also can add new events with an add new event link (100) and view each event by whatever specific name is given. Within this function, the global administrator (10) has the security level to go in-depth with these events by such items as seeing the status and numbers of business issues such as claims fall within each event. Further moving through this feature of the present invention permits access that gleans information on personnel performance in regard to that specific event. The global administrator (10) can even use this function to sort the highest to the lowest performers off all the people working on that specific event. An event can pertain to such example as a hurricane in the insurance claims industry to a new construction contract in that business.

The global administrator (10) also has complete access through the present invention to perform all managing and monitoring functions related to the specific business involved. This includes access to a manage business specific items link (110). This leads the global administrator (10) to have the ability to access an add new business specific item link (120) to upload new business notices generated from clients and associate them with another the business and ultimately assign the client's new business to those within the company chain of command via the present invention. An add business specific items in bulk link (130) permits the global administrator (10) to add new business in bulk, or larger groupings, to the present invention. A reassign business specific item link (140) permits the global administrator (10) to reassign any business-specific item or client file to another user if necessary. Additionally, the global administrator (10) has access with the present invention to use an activate manager assignment link (150) where any open business or client files that have not been assigned can be assigned to a user higher in the chain of command so they, in turn, can assign the client file to specific individuals who will be actually performing the work. Meanwhile, a reopen client file link (160) permits a global administrator (10) to reopen a file that had previously been closed. The reopen client file link (160) can then lead the global administrator to reassign the client file or even link that client file to others relating to that client.

The global administrator (10) also has complete access to the assignment map (170) of the present invention. This allows the global administrator (10) to see every business or client file that has not been assigned. The global administrator (10) can view the assignment map (170) on a map overview (240). The global administrator (10) then has access to make multiple assignments to virtually anyone in the company chain of command based on very specific criteria. These criteria can be location of the assignee in relation to the client, where the assignee is licensed if relevant, etc. The present invention permits the global administrator (10) to cater the criteria to his or her needs or use predetermined criteria.

In conjunction with the assignment map (170), the global administrator (10) also has access to the assignment network (180) of the present invention. This permits the global administrator (10) to see the availability of all his or her relevant personnel within the company hierarchy. The assignment network (180) of the present invention features a map of the relevant country (250). The global administrator (10) may then click on a relevant state or province where he or she can see how many people are within that state or province that meet the criteria needed for that particular client file. The global administrator (10) can then use this function of the present invention to search for potential assignees based on who is closest in terms of mileage or kilometers to the site of the client. This element of the present invention also allows the global administrator (10) to pinpoint certain confined areas of location to search for relevant personnel who meet the required criteria. For example, a global administrator (10) in a U.S. insurance claims business can click on the state where a claim has been submitted, and then, possessing a predetermined criteria for a claims adjuster, click on a county to see which qualified adjusters in that county are available to aid the client. The global administrator (10) also can access the present invention to review all subrogation possibilities by state, province or county and export these to a chart.

A status map (200) also can be accessed by the global administrator (10) to view all ongoing elements through the use of a map. This status map (200) can focus in on a state/province or county so that the global administrator (10) can view every client file that is currently in progress in those locations. This element of the present invention also permits the global administrator (10) to easily see what the status these files are at.

Another geographic element of the present invention that is limited to a global administrator is an indemnity trend link (230). In the context of the insurance claim industry, this would be an indemnity claims trend. This element of the present invention shows a map of the country that will give average cost per state/province or by county that the client has spent in indemnity dollars. By clicking on a geographic area such as a state/province to zoom in, the global administrator (10) can review the counties in order to ultimately assess the average RCV cost. This information is gleaned from indemnity billing information inserted by an adjuster after a claim has been completed.

The global administrator (10) has access to all ongoing and closed client files. Through an advance file search (190) of the present invention, the global administrator (10) can search for a wide-array of specifics involving client files. An insurance claims industry example includes such items as property claims broken down by daily and catastrophic, as well as more specific items such as assigned adjustors, assigned team leaders or assigned account managers. This feature of the present invention provides the global administrator (10) with complete monitoring access of his business. The advance file search (190) also permits the global administrator (10) to conduct a search through such elements as assigned client number, client name, and virtually any other conceivable identifier.

In the preferred embodiment of the present invention, the global administrator (10) has complete access over all of the functions. However, this does not necessarily mean that others within the business chain of command must have inferior access to the present invention. The global administrator (10) has complete access and can make decisions on which personnel gets what level of access. In many businesses, an administrator will technically remain a tier below the global administrator (10), but would still have nearly equal access privileges to the present invention. Other personnel below the administrator in the chain of command obviously would have more restrictive access to the present invention. In the preferred embodiment of the present invention, access would be based on the nature of the individual positions help by each person in relation to the business.

In FIG. 2, we see an embodiment of the present invention in terms of a flow chart relating to the workflow of a client file. One embodiment of the present invention adopts a numerical system to label the status of client files in regard to an assignment-based network-oriented business. An example of this is 0 through 6. 0 represents a time when a client file or job is in existence but unassigned. 1 means that an assignment was made but has not yet moved to take on the file. 2 tells the administrator that the assigner individual had indeed picked up the file while 3 signifies that the assigned individual has actually seen the client or relevant item involved. 4 provides information surrounding such detailed items as appraisals in the case of the insurance claims industry, while 5 states whether the file was accepted or rejected. 6 indicates that the file is closed. FIG. 2 and FIG. 3 show us detailed flow charts related to the workflow and overview respectively, where it becomes apparent where the numerical embodiment can apply to the present invention.

In FIG. 2, we see a job entered into system (300). Immediately after, the present invention provides a job assigned tracking number (310) and job data storage (320) commences. Subsequently, an automatic notification of new job (330) informs users of the present invention about the initial phase of the client file. At this point, FIG. 2 shows us that the job is assigned to service provider (340), with service provider data storage (350) commencing as well. An automatic service provider notification (360) informs the relevant service provider of the new client file or job that has entered into the system of the present invention. The service provider is the individual who ultimately will be the person who will physically deal directly with the client or job. This can be a claims adjuster in the context of the insurance claims industry or a contractor in that business.

After the automatic service provider notification (360), the service provider must decide whether he or she accepts job (370). If it is rejected for whatever reason, the process as demonstrated by FIG. 2 returns to job assigned to service provider (340). However, if service provider accepts job (370), then service provider directly engages job (375) and files report and uploads documentation (380). At this point, an automatic notice review requirement (390) is dispatched throughout the present invention's system. This automatic notice review requirement (390) prompts an administrator review of report and documentation (420). From there, the report must meet requirements (430) as dictated through predetermined or spontaneous decisions based on the policy-makers of the business. If the report does not meet requirements (430), an automatic notification of service provider (410) is dispatched into the present invention, which returns the process back to the point in FIG. 2 where the service provider files report and uploads documentation (380). But if the report meets requirements (430), an automatic client notification (440) is dispatched from the present invention. At that point, there is a client review of report and documentation (450). From there, client approves report (460). However, if the client does not approve of the report, an automatic notification to administrator and service provider (400) is dispatched from the present invention. From there, the service provider files report and uploads documentation (380) again and the process of FIG. 2 repeats itself until client approves report (460).

Once client approves report (460), the job is closed (470) and is filed into final job data storage (490). Subsequently, the final step in the job workflow as detailed in FIG. 2 is a billing report is generated (490).

In an additional embodiment of the present invention, the point in FIG. 2 where we see a job entered into the system (300) can also be numerically categorized as the number 0 in terms of numerical status. A client file can then be categorized as 1 when job assigned to service provider (340) and 2 when service provider accepts job (370). In 3 of this embodiment of the present invention, the service provider directly engages job (375) and files report and uploads documentation (380). In 4, the report meets requirements (430) and then, in 5, the client approves report (460). This finally leads to 6 of the numerical status classification of this additional embodiment of the present invention, and the job is closed (470).

In FIG. 3, we see an overview example of how the present invention can progress in the context of the insurance claims industry. While the present invention applies to a number of personnel-oriented, assignment-based industries, the insurance claims business offers a relevant and representative example in relation to the present invention.

FIG. 3 shows us that the insurance claims industry example begins with the claim information (500). A weighted professional service provider list (510) must be created through links provided in the present invention that includes requirements such as professional qualifications (520), carrier/provider requirements (530), professional service provider proximity (540) and professional service provider performance rating (550). Of course, someone such as the global administrator (10) can access all of these elements with the security levels as defined in FIG. 1. Once the weighted service provider list (510) is created to the desired level of efficiency, a professional service provider assignment (560) is made. In the example of the claims industry, this will be an adjuster. After the professional service provider assignment (560), the assignment is accepted (570). If it is rejected, the process of FIG. 3 reverts back to professional service provider assignment (560). This can happen because the present invention permits the weighted service provider list (510) to list the names of all the service providers based on the required criteria.

Once the assignment is accepted (570), the claim investigation process (580) begins. Items such as carrier rules (620), independent service firm rules (630) and online status reports (640) all must be taken into account during the claim investigation process (580). These elements of the present invention can be changed to fit those requirements and unique aspects of other industries as well. But after the claim investigation process (580), there is an administrator review (600). If it is rejected, the professional service provider work product (610) is reviewed and the process is sent back to the claim investigation process (580) of FIG. 3. However, if the administrator review (590) is approved, the claim investigation process (580) falls under an examiner review (600). If that is rejected, the process reverts back to the professional service provider work product (610) of FIG. 3. But if the examiner review (600) is approved, the client file subsequently goes to indemnification (650) and professional service provider performance data file (660). From indemnification (650) and claim data (680), online reports (670) are created and stored. Finally, the claim can be closed (690).

In FIGS. 4, 5, and 6, we see a detailed flow chart of how the process works in regard to a service provider map and routing information of the present invention. FIGS. 4, 5 and 6 demonstrates all of the links and resources available to a user with access to the present invention as described in FIG. 1. The details in FIGS. 4, 5 and 6 show an embodiment of the present invention in dealing with an assignment-based business such as that in the insurance claims industry. Much of FIGS. 4, 5 and 6 relates to the assignment map (170) as described in FIG. 1.

FIG. 4 shows us that much of the process in relation to the details surrounding dealing with service providers begins with job data (700). In addition, service provider location (710) also is taken into account. From there, the user can match location and appointment data (720) to get a detailed understanding of where the job is in relation to the appointment information as defined in FIG. 1, FIG. 2 and FIG. 3. The user can then gain a lot of useful information such as lookup current and forecast weather for area of appointments (725), display appointment locations, jobs, calendar and weather radar (730), adjust map display, location, magnification, size (740) as well as search for local service (750). Because weather conditions play an important part in making appointments and scheduling, a user also may click on weather map (820) and open weather forecast page (850). Much of the process of gaining information in regard to a service provider map and routing information of the present invention is gleaned by using a computer mouse and clicker.

For example, as seen in FIG. 4, a user can reach the appointment editor of the present invention by clicking on time/day on calendar (800) or moving mouse over job in job list (780), highlight appointment on calendar (830), click on edit appointment (860) and then check if job passed (1000) to the service provider in relation to the appointment as we see in FIG. 6. Taking into account appointment data (705) and job data (700), the user can then learn if the appointment time is free (1010) or clear appointment time (1020) if not as we see with the continuation of the flow chart on FIG. 6. Once the appointment time is free (1010), user enters appointment information (1030). The present invention will ensure that the data is entered correctly (1040). If it is incorrect, the user enters appointment information (1030) again as seen in FIG. 6. Once it is confirmed that the data is entered correctly (1040), geographical data (1060) is taken into account as the user finds the latitude/longitude of appointment location (1050). This is merely one embodiment as other exact coordinates also may be used. Once this location information is obtained in regard to the appointment editor, the user can save appointment data and update job status (1070), where the information is filed with the job data (700) and appointment data (705). From this point, such links of the present invention as the display appointment locations, claims, calendar and weather radar (730), adjust map display, location, magnification, size (740), and lookup current and forecast weather for area of appointments (725) can be maximized.

If a user wishes to display job summary (880) as we see in FIG. 4, he or she may move mouse over job or appointment on assignment map (790) and display summary information and edit link (840). The user then can click on edit job (870) and will display job summary (880).

In relation to routing, FIG. 4 shows us that a user can click on route link (810). Working in conjunction with job data (700) and appointment data (705), the user can get appointments for day, with job data (890) as we see in the continuation of the flow chart in FIG. 5. Then, taking into account weather forecasts (910) and geographical location data (920) also seen in FIG. 5, the user may get map for appointment area and weather forecast for area (900). This process of aiding in the routing process proceeds as the user can generate driving instructions to each appointment (930) and get road/traffic advisories for route (940) in conjunction with road/traffic advisories (950) information included and accessible in the present invention. The present invention also can display location weather forecast and driving instructions with traffic advisories and a map for each appointment (960). At this point, FIG. 5 shows us that the user can then print route (980), send route via email (970) and/or transfer route to GPS navigation system (990).

It is to be understood that someone skilled in the field of the invention can accomplish all processes, communications, and operations explained above, unless specifically explained otherwise.

The foregoing descriptions are not limited to the sole embodiment(s) described, but are within the scope of the following claims.

We claim:

1. A method for managing a business, comprising:
locating a geographic area for a project;
locating individuals geographically close to the project;
researching criteria regarding individuals;
assigning at least one of the individuals to the project;
accepting assignment of at least one of the individuals to the project;
providing detailed information about the project; and
providing forms and workflow routing for the project.

2. The method of claim 1, wherein said locating a geographic area for a project employs mapping software.

3. The method of claim 1, wherein said locating a geographic area for a project employs providing directions to the project.

4. The method of claim 1, wherein said researching criteria regarding individuals is researching the experience of the individuals.

5. The method of claim 1, wherein said accepting assignment of at least one of the individuals to the project is one of the individuals accepting responsibility for the project.

6. The method of claim 1, wherein providing detailed information about the project is conveying the degree of importance of the project.

7. The method of claim 1, wherein providing detailed information about the project is maintaining a current status of completion of the project.

8. The method of claim 1, wherein providing forms and workflow routing for the project has a database of forms necessary for completing the project.

9. The method of claim 1, wherein providing forms and workflow routing for the project has a system for assigning tasks to different parties.

10. The method of claim 1, wherein said locating a geographic area for a project employs mapping software and providing directions to the project.

11. The method of claim 1, wherein said researching criteria regarding individuals is researching the experience of the individuals, and wherein said accepting assignment of at least one of the individuals to the project is one of the individuals accepting responsibility for the project.

12. The method of claim 1, wherein providing detailed information about the project is conveying the degree of importance of the project and maintaining a current status of completion of the project.

13. The method of claim 1, wherein providing forms and workflow routing for the project has a database of forms necessary for completing the project and a system for assigning tasks to different parties.

14. The method of claim 10, wherein said researching criteria regarding individuals is researching the experience of the individuals, and wherein said accepting assignment of at least one of the individuals to the project is one of the individuals accepting responsibility for the project.

15. The method of claim 10, wherein providing detailed information about the project is conveying the degree of importance of the project and maintaining a current status of completion of the project.

16. The method of claim 10, wherein providing forms and workflow routing for the project has a database of forms necessary for completing the project and a system for assigning tasks to different parties.

17. The method of claim 14, wherein providing detailed information about the project is conveying the degree of importance of the project and maintaining a current status of completion of the project.

18. The method of claim 14, wherein providing forms and workflow routing for the project has a database of forms necessary for completing the project and a system for assigning tasks to different parties.

19. The method of claim 17, wherein providing forms and workflow routing for the project has a database of forms necessary for completing the project and a system for assigning tasks to different parties.
